(19) United States
(12) Patent Application Publication
(10) Pub. No.: US 2013/0291536 A1
(43) Pub. Date: Nov. 7, 2013

(54) INTERNAL COMBUSTION ENGINE

(71) Applicant: DAIMLER AG, Stuttgart (DE)

(72) Inventors: Thomas Koch, Boeblingen (DE); Johannes Ritzinger, Stuttgart (DE)

(21) Appl. No.: 13/783,261

(22) Filed: Mar. 2, 2013

(30) Foreign Application Priority Data
Mar. 2, 2012 (DE) 10 2012 004 368.6

(51) Int. Cl. F02M 25/07

(52) U.S. Cl. CPC F02M 25/0712
USPC 60/599; 123/563

(57) ABSTRACT

An internal combustion with a fresh air supply system, and an exhaust gas system including an exhaust gas turbocharger, which has a turbine arranged in the exhaust gas system and a compressor arranged in the fresh air supply system and a high-pressure exhaust gas recirculation pipe extending from the exhaust gas system upstream of the turbine to a point of the fresh air supply system downstream of the charge air cooler, and a low pressure exhaust gas recirculation pipe extending from a point of the exhaust gas system downstream of the turbine to a point of the fresh air supply system upstream of the compressor and a condensate collection device arranged in the fresh air supply system at, or downstream of, the connecting point of the high pressure recirculation line to the fresh air supply system for the removal of condensate.

The present invention relates to an internal combustion engine, in particular a diesel engine or a spark-ignition engine. The invention also relates to a method for the operation of such an internal combustion engine.

### BACKGROUND OF THE INVENTION

In conventional internal combustion engines, in particular in diesel engines or spark-ignition engines, it is known that the emission of exhaust gases from the internal combustion engine, the fuel consumption of the internal combustion engine and also the thermal loading of the internal combustion engine can be reduced by means of Exhaust Gas Recirculation (EGR). An exhaust gas recirculation system operating in a so-called full-load operation can significantly reduce the temperature of the exhaust gas, which on the one hand reduces the likelihood for the need for a separate means of cooling, for example by making the fuel mixture richer and on the other hand, opens up the possibility of reducing manufacturing costs through the possibility of the use of more favorably-priced materials, in particular in a turbocharger system for the internal combustion engine. In full-load operation the exhaust gas recirculation has to be cooled, in order to reduce a tendency towards engine knocking of the internal combustion engine. In so-called part-load operation, on the other hand, it may be useful to introduce the exhaust gases fed back to the internal combustion engine in an uncooled condition, since in this way the internal combustion engine can be de-throttled and the speed of combustion of an air-fuel mixture in the internal combustion engine is increased, which can have a favorable influence on the fuel consumption of the internal combustion engine.

On supercharged internal combustion engines with conventional exhaust gas recirculation a so-called ‘cooled exhaust gas recirculation takes place, usually on the so-called low pressure side’ of the exhaust gas recirculation, i.e. the exhaust gas generated by the internal combustion engine is removed downstream of a turbine of an exhaust gas turbocharger on the exhaust pipe and fed into the fresh air pipe ahead of the compressor of the exhaust gas turbocharger. By this means a temperature in the intake pipe of the internal combustion engine can be kept relatively low despite the exhaust gas recirculation, since the re-circulated exhaust gas can be cooled by both an exhaust gas recirculation cooler and a charge air cooler.

Under certain ambient conditions, however, water vapor condensed to water can precipitate out of the unburnt gas to be fed to the internal combustion engine by means of a fresh air system. In similar fashion, water can also precipitate out of the exhaust gas to be fed back to the internal combustion engine by means of the exhaust gas recirculation system.

Preferably such a condensation process takes place in the charge air cooler of the internal combustion engine. In practice in the operation of the internal combustion engine in a vehicle there is the danger, in particular at low ambient temperatures that such condensation of water vapor in exhaust gases may occur.

The condensed water in the exhaust gas can lead to sooting and the corrosion of various structural elements of the charge air cooler. Such undesired effects may occur to a greater extent due to the presence of sulphur in the fuel fed to the internal combustion engine. In practice in the operation of the internal combustion engine in a vehicle at particularly low ambient temperatures, an additional undesirable effect can occur, namely the freezing out of the condensate as ice, which can lead to a fluidic blockade of parts of the exhaust gas recirculation system.

DE 10 2008 043 802 A1 describes a device for the recirculation of exhaust gas in an internal combustion engine, comprising an exhaust gas recirculation line and a humidifier, which is arranged in the exhaust gas recirculation line in order to cool and simultaneously humidify the exhaust gas to be fed to the internal combustion engine.

DE 10 2006 054 227 A1 discloses a method for the reduction of the pollutant emission of an internal combustion engine, in particular of a diesel engine, of a motor vehicle using water recovered within the vehicle. This water is fed to the internal combustion engine indirectly via at least one material stream. According to the method water is recovered by cooling and by condensation of ambient air and stored intermediately within the motor vehicle.

DE 10 2008 056 337 A1 relates to an internal combustion engine, in particular a diesel engine or a spark-ignition engine, with a fresh air system and an exhaust system. A charge air cooler is arranged in the fresh air system, and at least one exhaust turbocharger is arranged in the exhaust system. The exhaust turbocharger has a compressor arranged in the fresh air system downstream of the charge air cooler and a turbine arranged in the exhaust system. A high pressure exhaust gas recirculation system branches from the exhaust system upstream of the turbine of the exhaust gas turbocharger, comprises a high pressure exhaust gas recirculation valve and opens into the fresh air system downstream of the charge air cooler. A low pressure exhaust gas recirculation pipe branches off from the exhaust system downstream of the turbine of the exhaust gas supercharger, has a low pressure exhaust gas recirculation valve and opens into the fresh air system upstream of the compressor of the exhaust gas turbocharger. The known internal combustion engine has an exhaust gas retention flap, which is arranged in the exhaust system downstream of the branching off of the low pressure exhaust gas recirculation pipe. Further, a charge air cooler bypass is arranged in the fresh air system of the internal combustion engine, which circumvents the charge air cooler.

JP 2010-025034 describes an exhaust gas recirculation device for an internal combustion engine, which connects a section between an exhaust system and a fresh air system of the internal combustion engine by means of an exhaust pipe, which comprises an exhaust gas cooler and an exhaust gas valve. The exhaust gas device has a collector tank for the collection of condensed water. The exhaust gas device also has a condensed water feeding device, which feeds condensed water, which is stored in the collector tank, to the fresh air system downstream of the exhaust gas recirculation valve.

US 2011/0094219 A1 describes a method for a charge air cooler coupled with an internal combustion engine, wherein in accordance with the method condensate is collected in a condensate collection device. In a first operating mode of the internal combustion engine the condensate is temporarily stored in the condensate collection device and in a second operating mode discharged in a discharge pipe. The first operating condition can, in particular, be a full-load operating mode of the internal combustion engine, wherein the condensate is released after the temporary storage. The second operating mode, on the other hand, may be a part-load operation of the internal combustion engine.

DE 10 2007 007 092 A1 deals with an exhaust gas recirculation system for an internal combustion engine with an exhaust gas turbocharger, whose turbine is arranged in an exhaust gas line and whose compressor is arranged in a fresh air line. The exhaust gas recirculation system comprises high pressure and low pressure exhaust gas recirculation. The turbine is designed to convey the exhaust gas and is connected with an exhaust manifold; the compressor is connected via the fresh air line to an air collector of the internal combustion engine. The exhaust gas from the exhaust line is fed back into the fresh air line ahead of the compressor. A charge air cooler is arranged in the fresh air circuit between the compressor and the air collector, which has an outlet for condensate condensed in the charge air cooler. The outlet is connected with a condensate return location in the fresh air line via a condensate return, and hence connected in the direction of flow of the fresh air after the charge air cooler and ahead of the inlet valves of the internal combustion engine.

U.S. Pat. No. 6,301,887 B1 describes a low pressure exhaust gas recirculation system for a motor vehicle with a diesel engine. An intercooler is arranged between the compressor and the diesel engine, which has a collector tank for water that has dropped into the intercooler.

It is the object of the present invention to provide an improved internal combustion engine and to provide a method for the operation of such an internal combustion engine, by means of which the disadvantages named above are eliminated, or at least alleviated.

### SUMMARY OF THE INVENTION

An internal combustion with a fresh air supply system, and an exhaust gas system including an exhaust gas turbocharger, which has a turbine arranged in the exhaust gas system and a compressor arranged in the fresh air supply system and a high-pressure exhaust gas recirculation pipe extending from the exhaust gas system upstream of the turbine to a point of the fresh air supply system downstream of the charge air cooler, and a low pressure exhaust gas recirculation pipe extending from a point of the exhaust gas system downstream of the turbine to a point of the fresh air supply system upstream of the compressor and a condensate collection device arranged in the fresh air supply system at, or downstream of, the connecting point of the high pressure recirculation line to the fresh air supply system for the removal of condensate.

According to the invention, by means of the condensate collection device it is possible, in conjunction with the exhaust gas recirculation, to specifically collect water that has dropped out in a collection device provided for this purpose, that is the condensate collection device according to the invention. In this way it is first prevented that the water vapor condensed from exhaust gas or from fresh air into reaches other parts of the exhaust gas recirculation system of the internal combustion engine and causes there malfunctions of the internal combustion engine or even to damage to the internal combustion engine. An undesirable corrosion or sooting of the charge air cooler through water resulting from condensation can likewise be largely prevented or at least very significantly reduced by this means.

This correspondingly applies to undesirable icing, when water has formed as ice due to low ambient temperatures. This also applies to other components of the internal combustion engine according to the invention, in particular in the area of the fresh air system of the internal combustion engine.

In a technically particularly easily achieved embodiment the condensate collection device can take the form of a collecting tank. The manufacturing costs of the internal combustion engine according to the invention can be reduced by this means.

In order to prevent the quantity of condensed vapors in the condensate collection device from exceeding a maximum value, in a further developed embodiment it can be considered, that the condensate collection device be incorporated in such a way at the point of entry, or in the fresh air system, that the condensate collected in the condensate collection device can at least be partly vaporized by means of the exhaust gas returned through the low pressure or high pressure exhaust gas recirculation line. This means, that in the condensate collection device, water vapor that has taken the form of condensate can at least be partly vaporized again by means of the thermal energy of the exhaust gases returned through the low-pressure or high-pressure exhaust gas recirculation pipe.

In a further developed embodiment a quantity of exhaust gas to be re-circulated via the high pressure exhaust gas recirculation system and used for the vaporization of the water in the condensate collection device, is variable. Consequently, through a variation of the quantity of exhaust gas re-circulated via the low-pressure or high-pressure exhaust gas recirculation pipe a targeted re-vaporization for the water in the condensate collection device can be controlled.

In a particularly preferred embodiment of the invention the internal combustion engine can have a control device for the adjustment of a first and/or second quantity of exhaust gases. In this embodiment the first quantity of exhaust gas corresponds to that quantity, which is re-circulated by means of the high-pressure exhaust gas recirculation pipe. Accordingly, the second quantity is that quantity, which is re-circulated by means of the low-pressure exhaust gas recirculation pipe. The first and second quantities of exhaust gas are preferably adjustable by means of the high-pressure exhaust gas recirculation valve and by means of the law-pressure exhaust gas recirculation valve, respectively. Which quantity of exhaust gas is re-circulated can thus be regulated by the control device. The control device can also be used to regulate which quantity of exhaust gas is re-circulated via the high-pressure exhaust gas recirculation pipe and via the low-pressure exhaust gas recirculation pipe. Since exhaust gas re-circulated via the high-pressure exhaust gas recirculation pipe has a clearly higher temperature than exhaust gas re-circulated via the low-pressure exhaust gas recirculation pipe, the temperature and thus also the thermal energy of the exhaust gases flowing through the condensate collection device can be adjusted. Since the degree of vaporization on the vaporization of water in the condensate collecting tank depends essentially on the temperature of the exhaust gas, by means of an adjustable distribution of exhaust gas in the low-pressure and high-pressure exhaust gas recirculation pipes it is possible by elegant means to regulate the extent to which a condensate in the condensate collection device should again be vaporized through thermal interaction with the exhaust gas flowing through the condensate collection device.

For the case, wherein in spite of the preparation of a condensate collection device according to the invention, nevertheless condensate, in particular water, should formin the low-pressure and/or the high-pressure exhaust gas recirculation valve, which in the most unfavorable case leads to freezing in the low-pressure and/or high-pressure exhaust gas recirculation valves and causes one or both of these to freeze and thus causes fluidic blocking in the valves, in the following a special embodiment is described for a low-pressure and/or high-pressure exhaust gas recirculation valve (referred to in the following as a “valve device”), which, as such, is already capable of self-protection and on which the danger of a fluidic blockade due to water frozen to ice is already largely avoided.

A valve of such a type is based on the general principle, that in the valve device in addition to a main flow channel a secondary flow channel is also provided, which can be used in the case of icing of the main flow channel and the associated fluidic blockade of the main flow channel as a type of “Bypass” channel.

Accordingly, such a valve device has a main flow channel, which preferably is shaped essentially in the form of a pipe and further a first fluid admission opening with a first cross-section area for the admission of a fluid into the first flow channel. Further, the valve device according to the invention also comprises a secondary flow channel inside the main flow channel, which preferably is likewise essentially pipe-shaped. The main stream channel has now a first fluid admission opening for the admission of a fluid into the main stream channel with a first cross-sectional area and accordingly the secondary flow channel has a second fluid admission opening with a second cross-section area for the admission of the fluid into the secondary flow channel.

In a normal operating mode, the valve device enables fluid to flow through the main flow channel of the valve device, but not through the secondary flow channel. In order then to prevent the flow of fluid through the secondary flow channel in the normal operating mode, the valve device has a control body, by means of which both the first and also the secondary fluid admission opening can be selectively closed or at least partly opened. In the normal operating mode the secondary fluid admission opening of the secondary flow channel is closed by means of the control body, while the first fluid admission opening can be set in the normal operating mode between an opened and a closed condition. In the normal operating mode, the valve device works as a conventional valve, in that the first fluid admission opening is closed or opened by means of the control body. Intermediate conditions between the opened and the closed conditions are also conceivable.

In a so-called “Icing Mode”, differing from the normal operating mode, it is now possible by means of the control body to also open the second fluid admission opening of the secondary flow channel. This is necessary, if in one inlet area of the first fluid admission opening water vapor condensed to water has collected and has frozen to become ice, which in actual operation of the valve device in the internal combustion engine according to the invention can be the case. An ice formation of this type, in particular in the area of the main flow channel, can lead to a complete fluidic blockage of the main flow channel in the normal operating condition of the valve device. Through an opening of the secondary flow channel, arranged within the main flow channel, by means of the control body a replacement fluidic channel can be provided, through which the exhaust gas can flow through the valve device so long as the main stream channel is blocked due to icing.

For the case, wherein the valve device has exhaust gases flowing through it, the ice formed in the main flow channel can be warmed up by the exhaust gases now flowing through the secondary flow channel and in the ideal case completely melted. As soon as the ice formed in the main flow channel has melted and the main channel is rendered free again for fluid flow, the control body can close the secondary flow channel, which results in a switchover of the valve device from the “Icing Mode” back to the normal operating mode.

Now again, with reference to the condensate collection device of the internal combustion engine according to the invention, it is possible in simple way to determine which quantity of condensed vapor has accrued in the condensate collection device, so that in a further developed form, the internal combustion engine can be equipped with a condensate measuring device for the determination of a quantity of condensate in the condensate collection device. Fundamentally, such a measuring device can be a conventional fluid sensor.

In a further developed form a first and/or second quantity of exhaust gas can now be adjusted by means of the control device, depending on the operating mode of the internal combustion engine. Alternatively or additionally, depending on the further developed embodiment, the first and/or second quantity of exhaust gas can be adjusted by the control device as a function of the quantity of condensate in the condensate collection device determined by the condensate measuring device. In the first case the recirculation of the exhaust gas takes place essentially in a first operating condition of the internal combustion engine via the low-pressure exhaust gas recirculation pipe. The first operating condition can thereby in particular be a full-load operating mode of the internal combustion engine, wherein through recirculation of exhaust gas via the low pressure exhaust gas recirculation pipe a tendency of the internal combustion engine to knocking is largely avoided and the temperature of the re-circulated exhaust gases can be kept relatively low by means of the exhaust gas re-circulation cooler. In a second operating mode of the internal combustion engine, which can in particular be a part-load operating condition of the internal combustion engine, the recirculation of the exhaust gas then takes place essentially via the high-pressure exhaust gas recirculation pipe, so that the internal combustion engine can be de-throttled by means of the uncooled exhaust gases from the high-pressure exhaust gas recirculation pipe.

In a particularly preferred embodiment the internal combustion engine can, especially temporarily, be switched to the second operating mode, if by means of the condensate measuring device it is determined, that a quantity of condensate in the condensate collection device exceeds a predetermined threshold value. By switching over to the second operating mode, wherein the recirculation of the exhaust gas essentially takes place via the high-pressure exhaust gas recirculation pipe (full-load operating condition of the internal combustion engine), it can be achieved, that the exhaust gas flowing through the condensate collection device has a particularly high exhaust gas temperature, which supports an evaporation process of the condensate that has accrued in the condensate collection device, so that by this means the quantity of the condensate that has accrued in the condensate collection device can be reduced.

In a preferred embodiment the internal combustion engine is switched, in particular temporarily, to a second operating mode, when by means of the condensate measuring device it is determined that a specified threshold value for the quantity of condensate has been exceeded in the condensate collection device.

The invention further relates to a method for the operation of the previously explained internal combustion engine, in accordance with which in a first operating mode of the internal combustion engine the recirculation of the exhaust gas takes place essentially only via the low-pressure exhaust gas recirculation pipe, and in accordance with which in a second operating mode of the internal combustion engine the recirculation of the exhaust gas takes place essentially only via the high-pressure exhaust gas recirculation pipe.

In a further embodiment of the internal combustion engine according to the invention the control device of the internal combustion engine is developed and/or programmed for the execution of the operating method explained above.

Further important features and advantages of the invention result from the sub claims, from the drawings and from the related figure descriptions.

It is understood, that the above named features and the yet to be explained features can be applied not only in the respective given combinations, but also in other combinations or in isolated use, whilst remaining within the context of the present invention.

Preferred exemplary embodiments of the invention are explained in greater detail in the following description with reference to the accompanying drawings, wherein the same reference symbols relate to the same or similar or functionally similar components.

### BRIEF DESCRIPTION OF THE DRAWINGS

FIG. 1 Shows an exemplary version of an internal combustion engine according to the Invention, and

FIGS. 2a-2c show a detailed representation of a high pressure or low pressure exhaust gas recirculation valve of the internal combustion engine in FIG. 1.

### DESCRIPTION OF EXEMPLARY EMBODIMENTS

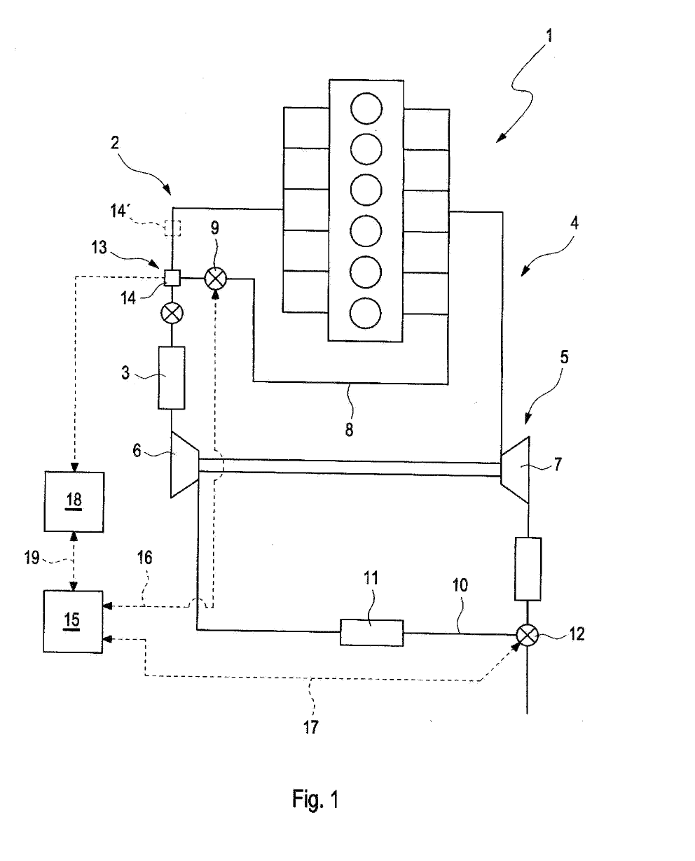

In FIG. 1 an internal combustion engine according to the invention is designated 1. The internal combustion engine 1 comprises a fresh air system 2, wherein a charge air cooler 3 is arranged. By means of the fresh air system 2 the internal combustion engine 1 can be supplied with fresh air. The internal combustion engine 1 further comprises an exhaust system 4 for the removal of exhaust gas from the internal combustion engine 1 as well as an exhaust gas turbocharger 5, which has a compressor 6 arranged in the fresh air system 2 upstream of the charge air cooler 3 and a turbine 7 arranged in the exhaust gas system 4. The internal combustion engine 1 also has a high-pressure exhaust gas recirculation pipe 8 for a partial recirculation of exhaust gas from the exhaust gas system 4 into the fresh air system 2. The high-pressure exhaust gas recirculation pipe 8 branches off upstream of the turbine 7 of the exhaust gas turbocharger 5 of the exhaust gas system 4. The high-pressure exhaust gas recirculation pipe 8 has further a high-pressure exhaust gas recirculation valve 9 and opens into the fresh air system 2 downstream of the charge air cooler 3 at a connection point 13. In addition to the high-pressure exhaust gas recirculation pipe 9 the internal combustion engine 1 according to the invention also comprises a low-pressure exhaust gas recirculation pipe 10 with an exhaust gas recirculation cooler 11 for the at least partial recirculation of exhaust gas from the exhaust gas system 4 into the fresh air system 2. The low-pressure exhaust gas recirculation pipe 10 has a low-pressure exhaust gas recirculation valve 12 and opens upstream of the compressor 6 of the exhaust gas turbocharger 5 into the fresh air system 2.

In addition the internal combustion engine 1 according to the invention has a condensate collection device 14 for the acceptance of a condensate. Such a condensate can be water condensed from vapor of the exhaust gas of the internal combustion engine 1 and/or from the fresh air to be fed to the internal combustion engine 1. Such a condensate can fall out from the recirculation of exhaust gas via the high-pressure exhaust gas recirculation pipe 8 or via the low-pressure exhaust gas recirculation pipe 10, in the latter case in particular from the flow of the exhaust gas through the exhaust gas recirculation cooler 11 or through the charge air cooler 3.

In accordance with the implementation example the condensate collection device 14 is arranged at the intersection point 13. In this way it is especially ascertained, that condensate from both the high-pressure exhaust gas recirculation pipe 8 and also the low-pressure exhaust gas recirculation pipe 10 is collected there.

In an alternative variant to the first exemplary embodiment, the condensate collection device 14′ can also be arranged downstream of the pipe intersection point 13, which is indicated in the representation in FIG. 1 by means of a dashed line. Also in this alternative exemplary embodiment it is ascertained, that in both the high-pressure exhaust gas recirculation pipe 8 and in the low-pressure exhaust gas recirculation pipe 10 water from the condensate collection device 14′ is received and can be collected.

The condensate collection devices 14, 14′ are preferably in the form of collecting tanks.

The condensate collection device 14, 14′ is now integrated at the pipe intersection point 13 or in the fresh air system 2 such that the water that has dropped into the condensate collection device 14, 14′ can be evaporated again and then, through thermal interaction, mixed with the exhaust gas flowing through the condensate collection device 14, 14′ and with the fresh air flowing through the condensate collection device 14, 14′.

Preferably in the adjustment of an evaporation rate of the condensate that has collected in the condensate collection device 14, 14′ (preferably water) a quantity of exhaust gas, which is re-circulated by way of the high-pressure exhaust gas recirculation pipe 8 or the low-pressure exhaust gas recirculation pipe 10 is variable. This quantity in turn can be readjusted by means of the high-pressure exhaust gas recirculation valve 9 and the low-pressure exhaust gas recirculation valve 12.

In the extreme case of a completely closed high-pressure exhaust gas recirculation valve 9, exhaust gas discharged from the combustion chamber 25 is only returned to the internal combustion engine 1 by way of the low-pressure exhaust gas recirculation pipe 10. Since exhaust gas returned to the internal combustion engine via the high-pressure exhaust gas recirculation pipe 8 has a relatively high temperature in comparison to that returned via the low-pressure exhaust gas recirculation pipe 10, exhaust gas returned in this way is particularly well suited for the re-evaporation of water collected in the condensate collection device 14, 14′ by thermal interaction. Through the arrangement of the mouth intersection 13, according to the invention, the exhaust gas re-circulated via the high-pressure exhaust gas recirculation pipe 8 flows completely through the condensate collection device 14, 14′, wherein the condensate to be evaporated is collected, before entry into the combustion chamber 25.

The internal combustion engine 1 may further include a control device 15 for the adjustment of a first quantity of exhaust gas, which has been re-circulated by way of the high-pressure exhaust gas recirculation pipe 8, and for the adjustment of a second quantity of exhaust gas, which has been re-circulated by way of the low-pressure exhaust gas recirculation pipe 10. For this purpose the control device 15 is in operative connection with high-pressure exhaust gas recirculation valve 9 and the low-pressure exhaust gas recirculation valve 12, as is indicated schematically in the representation in FIG. 1 by the broken lines 16, 17. Thereby, by means of the control device 15, a level of opening of both the high-pressure exhaust gas recirculation valve 9 and the low-pressure exhaust gas recirculation valve 12 can be set.

In a variant the internal combustion engine 1 can have a condensate measuring device 18, by means of which a quantity of condensate collected in the condensate collection device 14, 14′ can be determined. The condensate measuring device 18 can remain in communication with the control device 15 (see broken line 19 in FIG. 1), so that the quantity of condensate determined by the condensate measuring device 18 can be communicated to the control device 15. It is clear, that in a variant of the example embodiment the control device 15 can also incorporate the condensate measuring device 18. The condensate measuring device can, in particular, be in the form of a conventional liquid sensor.

By means of the control device 15 the first and second quantity of exhaust gas can now be set according to an instantaneous operating mode of the internal combustion engine 1. This means, that by means of the control device 15, which facilitates a control both of the high-pressure exhaust gas recirculation valve 8 and also of the low-pressure exhaust gas recirculation valve 12, respectively, the quantity of exhaust gas re-circulated through the high-pressure exhaust gas recirculation 8 and the low-pressure exhaust gas recirculation 10 can be adjusted. A first operating condition of the internal combustion engine 1 can thereby be a so-called full load operating condition of the internal combustion engine 1, wherein the re-circulating exhaust gas has to be cooled due to its very high temperature, in order to reduce a tendency to knocking of the internal combustion engine. Therefore, in the first operating condition the recirculation of the exhaust gas takes place essentially via the low-pressure exhaust gas recirculation 10, wherein the exhaust gas recirculation cooler 11 for the cooling of the exhaust gas is arranged. In the first operating mode, the low-pressure exhaust gas recirculation valve 12 is mostly open by means of the control device 15 and the high-pressure exhaust gas recirculation valve 9 is mostly closed.

Accordingly, in a second operating mode of the internal combustion engine 1 the recirculation of the exhaust gas takes place essentially via the high-pressure exhaust gas recirculation pipe 8. The second operating mode can thereby be in particular a partial-load operating mode of the internal combustion engine 1, wherein a temperature of the exhaust gas emerging from the combustion chamber 25 is relatively low, so that an additional cooling of the exhaust gas by means of the exhaust gas recirculation cooler 11 is not absolutely necessary. Consequently a recirculation of the exhaust gas can take place essentially via the high-pressure exhaust gas recirculation pipe 8. Correspondingly the high-pressure exhaust gas recirculation valve is largely opened by means of the control device 15 in the second operating mode of the high-pressure exhaust gas recirculation valve 9 and the low-pressure exhaust gas recirculation valve 12 is to a large extent closed. In the second operating mode an evaporation of the condensate collected in the condensate collection device 14, 14′, in particular of water, is especially strongly supported, since the exhaust gas flowing through the collection device 14, 14′ is at a particularly high temperature, as it is essentially re-circulated via the high-pressure exhaust gas recirculation pipe 8.

Now it can be conceived in a variant of the exemplary embodiment, that by means of the control device 15 and depending on the quantity of condensate determined by means of the condensate measuring device 18, that the above defined first and second quantity of exhaust gas can be set on a predetermined basis. In this way, water collected in the condensate collection device 14, 14′ can be evaporated in a targeted fashion, for example if the condensate collection device 14, 14′ is already completely full of condensate and therefore cannot accept any further condensate. In order in this case to be able to achieve an effective and fast evaporation of the condensate, the first quantity of exhaust gas, which is re-circulated by means of the high-pressure exhaust gas recirculation pipe 8, is accordingly selected such that it is correspondingly large, which can be achieved by means of an extensive opening of the high-pressure exhaust gas recirculation valve 9 and a complementary extensive closing of the low-pressure exhaust gas recirculation valve 12.

In a further developed variant of the exemplary embodiment the internal combustion engine 1 can be formed in such a way, that it is temporarily switched to the second operating condition, when by means of the condensate measuring device 18 it is determined that a defined quantity of condensate in the condensate collection device 14, 14′ exceeds a predetermined threshold value. By switching over to the second operating mode, as explained above, an evaporation of condensate in the condensate collection device is then targeted, such that the condensate in the condensate collection device 14, 14′ can be relatively quickly re-evaporated. In this way an undesired overshoot of the predetermined threshold value is avoided.

In a variant of the internal combustion engine 1 a throttle valve an be arranged downstream of the compressor 6.

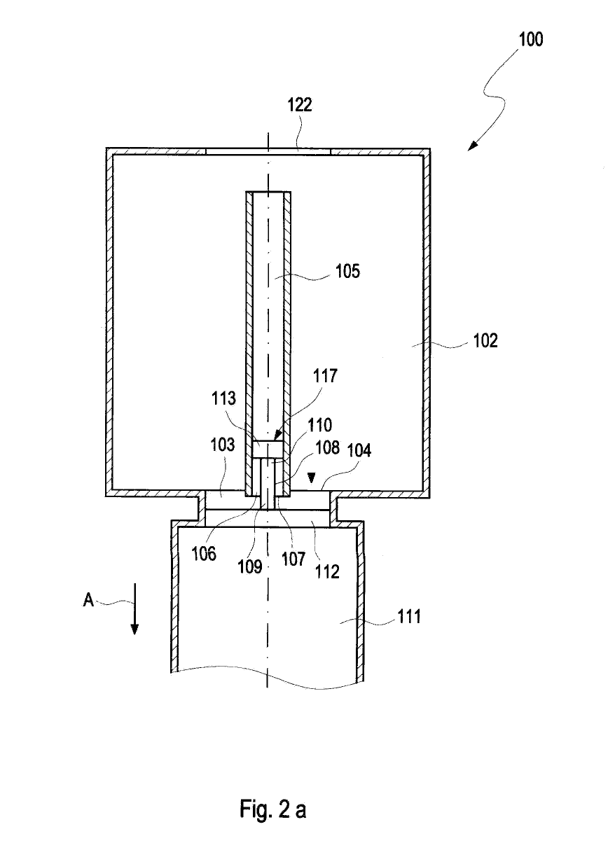

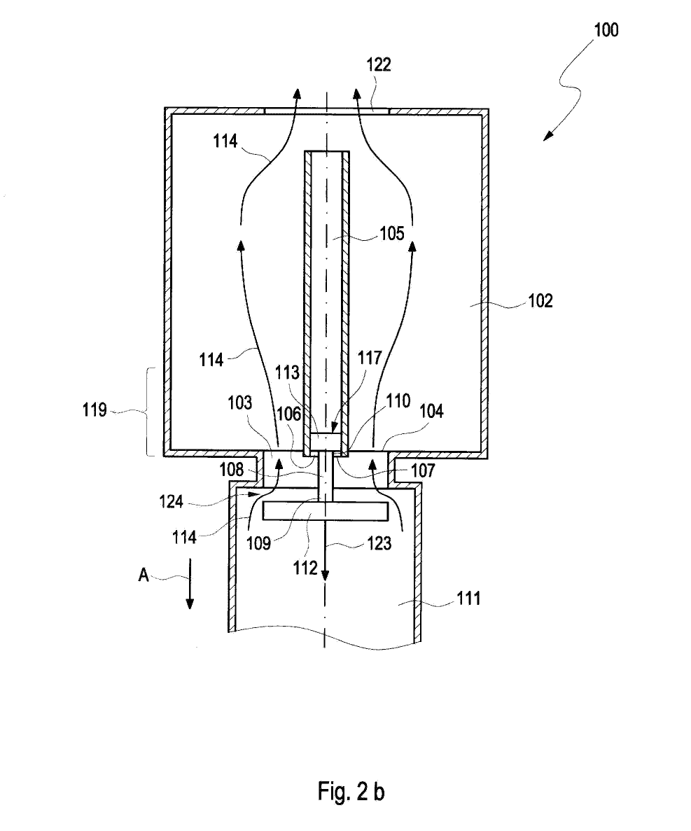

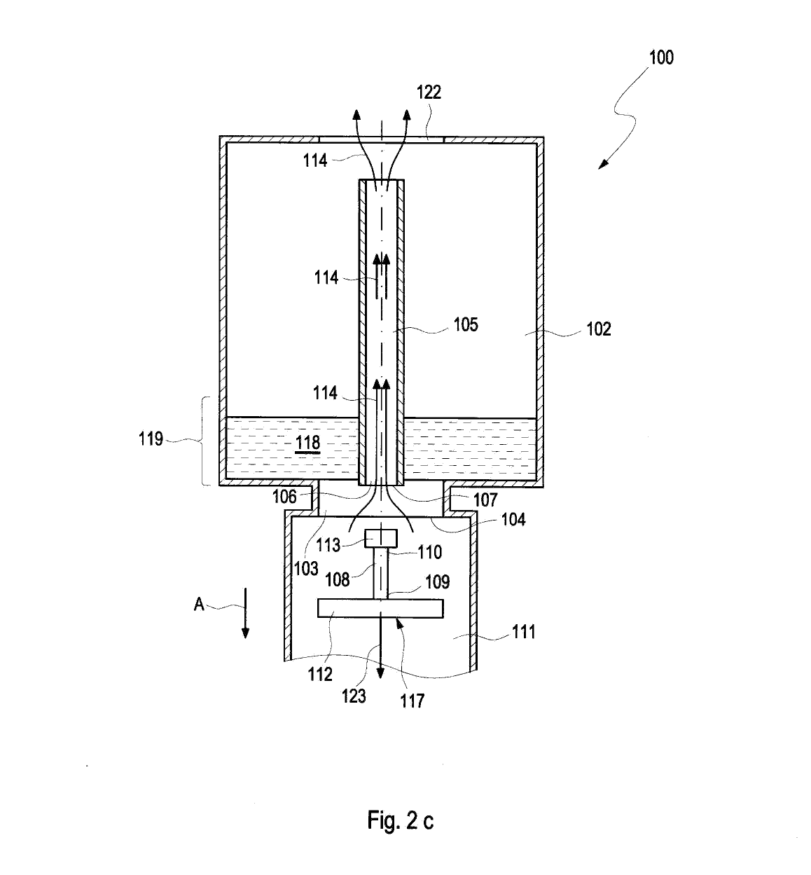

In the representation of FIG. 2a a further developed variant of the low-pressure and high-pressure exhaust gas recirculation valve 12, 9 (in the following referred to as “valve device”, with the reference symbol 100) is now explained, by means of which, through the provision of a so-called “de-icing mode” it can largely be excluded, that the valve device can be completely blocked to fluid due to icing.

For the case, that the valve device 100 is, for example, brought into use in conjunction with the internal combustion engine according to the invention, for a motor vehicle, on occurrence of relatively low ambient temperatures and despite the use of the condensate collection device 14, 14′ for the desired collection of condensate accruing from exhaust gases, under certain circumstances condensate can also collect in the low-pressure and high-pressure exhaust gas recirculation valve 12, 9 and—with sufficiently low ambient temperatures—even as ice, which can lead to an undesirable fluidic blockage of the valves.

In order to prevent such an undesirable fluidic blockage, the suggested valve device 100 can comprise a, preferably tube-shaped, main flow channel 102. The main flow channel 102 has thereby a fluid-admission opening 103 with a first cross-section area, which in the representation in FIG. 1 is identified by the line with the reference symbol 104. Via the first fluid admission opening 103 exhaust gas can be fed from the internal combustion engine 1 into the main flow channel 102.

Within the main flow channel 102 there is likewise a tube-shaped secondary flow channel 105. The secondary flow channel 105 has a second fluid admission opening 106 with a second cross-section, which is indicated in FIG. 2a by the line with the reference symbol 107. Via the second fluid admission opening 106 the exhaust gas can be admitted to the secondary flow channel 105. From the representation in FIG. 2a it follows directly, that the first fluid admission opening 103 surrounds the second fluid admission opening 106 in the form of a ring. It is clear, however, that many variants of the example embodiment are possible in terms of the geometry of the main and secondary flow channels, which in particular can also differ from the tube-shaped construction represented in FIG. 2a.

The valve device 100 in FIG. 2a comprises now further a control body 117, by means of which both the first, as well as the second fluid admission opening 103, 106 of the main flow and secondary flow channels 102, 105 can close or be at least partly open.

To this end the control body 117 can be moved in an axial direction A (see arrow in FIG. 2a) between three different positions. In the position shown in FIG. 2a both the first and also the second fluid admission openings 103, 106 of the main and secondary flow channels 102, 105 are closed to fluid, so that via an inlet area 111 of the valve device 100, which remains in fluid contact with both the main and also the secondary flow channels 102, 105, neither the main nor the secondary channels 102, 105 can be accessed.

To close the first and second fluid admission openings 103, 106 the control body 117 has a cylindrical type basic body 108 with a first and a second end section 109, 110. In the first position shown in FIG. 2a the cylindrical basic body 108 is arranged almost completely in the secondary flow channel 105. A first closing element 112 is positioned on the first end section 109 of the basic body 108, which as shown in FIG. 2a can take the form of a disc. In the position 117 of the control body shown in FIG. 2a, a first fluid admission opening 103 is completely blocked from fluid by the first closing element 112. As is immediately apparent from the representation in FIG. 2a, the first closing element 112 in this position automatically also closes the second fluid admission opening 106 fluid tight. Furthermore, a second closing element 113 is also positioned at the second end section 110 of the basic body 108, which in the position shown in FIG. 2a, closes the secondary flow channel 105 to fluid in addition to the first closing element 112.

In the representation in FIG. 2b the valve device 100 is now shown in a second position, which likewise can be adjusted in the normal operating mode of the valve device 100, and wherein (in contrast to the first position) the first fluid admission opening 103 is open, so that fluid from the admission area 111 can ingress into the main flow channel 102, which is indicated in FIG. 2b by the flow arrow with the reference symbol 114. After flowing through the main stream channel 102 the exhaust gas can again leave the valve device 100 in an outlet area 122, in the second position, shown in FIG. 2b, the secondary flow channel 105 is always closed to fluid in a first position by means of the second closing element 113 (likewise as shown in FIG. 1), so that exhaust gas can flow exclusively through the main flow channel 102, but not however, through the secondary flow channel 105.

As already explained, the first and second positions shown in the FIGS. 2a and 2b, respectively, correspond to a normal operating condition of the valve device. By a movement of the control body 117 between the first and second position the main flow channel 102 can be opened for the through flow of exhaust gas and closed again as required. A degree of opening of the first fluid admission opening 103 can be further enlarged by a movement of the control body 117, starting from the second position shown in FIG. 2b in the direction of the arrow 117. Then such a movement of the first closing element 112 in the axial direction A leads to an increase of an opening area 121 of the valve device 117. The movement of the control body 117 can thereby be continued up to a position of the control body 117, at which the second closing element 113 then closes the secondary flow channel 105 (not shown in FIG. 2b).

With the occurrence of relatively low ambient temperatures of the exhaust gas flowing through the valve device 100 water can now condense from the exhaust gas, freeze in the area 119 of the first fluid admission opening 103 of the main flow channel 102 and in the most unfavorable case cause a fluid blockage of the whole main flow channel 102, so that exhaust gas can no longer flow through the main flow channel 102.

This situation is now shown schematically in FIG. 2c, wherein the main flow channel 102 is blocked to fluid flow due to ice 118. In order to prevent an undesired blockage of exhaust gases in the admission area 111 of the valve device, so that fluid entering the valve device 100, for example exhaust gas, can still flow through the device, even in the event of icing, the control body 117 is now moved into the third position shown in FIG. 2c, wherein the second fluid admission opening 106 is no longer closed to the passage of fluid due to the second closing element 113 of the control body 117, but rather is free for the through flow of the fluid (arrow 114).

During the use of the valve device 100 as a high-pressure recirculation valve 9 or low-pressure exhaust gas recirculation valve 12 in the internal combustion engine 1 of the invention, due to the high temperature of the exhaust gas, now flowing through the secondary flow channel 105, the ice 118 formed in the main flow channel 102 is re-melted, so that after a short time also the main flow channel 102 can again be free for the through flow of exhaust gas. The valve device 100 can then again be switched to the normal operating mode (control body is switched back to the first or second position or into an intermediate position between the first and second position).

In a particularly preferred embodiment the secondary flow channel 105 can now be formed in the style of a stand pipe, as shown in the FIGS. 2a to 2c. In this case, wherein the stand pipe is aligned in a built-in condition in the internal combustion engine according to the invention in the direction of action of the force of gravity (i.e. the axial direction A points in the direction of the gravity force), the ice 118 shown in the FIG. 2c then falls onto the floor area 119 as water, collects there and then freezes in this area to ice. By this means it is ensured that any condensate forming in the valve device 100 collects in a defined area, namely the floor area 119 of the valve device 100.

What is claimed is:

1. An internal combustion engine (1), comprising
a fresh air system (2), with a charge air cooler (3) for feeding fresh air to the internal combustion engine (1),
an exhaust gas system (4) for the discharge of exhaust gas from the internal combustion engine (1),
at least one exhaust gas turbocharger (5), including a compressor (6) arranged in the fresh air system (2) upstream of the charge air cooler (3) and a turbine (7) arranged in the exhaust gas system (4),
a high-pressure exhaust gas recirculation pipe (8) extending between the exhaust gas system (4) and the fresh air system (2) for re-circulating exhaust gas from the exhaust gas system (4) to the fresh air system (2),
the high-pressure exhaust gas re-circulation pipe (8) branching off the exhaust gas system (4) upstream of the turbine (7) and including a high-pressure exhaust gas recirculation valve (9) and joining the fresh air system (2) downstream of the charge air cooler (3) at a connecting point (13),
a low-pressure exhaust gas recirculation pipe (10) including an exhaust gas recirculation cooler (11) for recirculating exhaust gas from the exhaust gas system (4) to the fresh air system (2),
the low-pressure exhaust gas recirculation pipe (11) branching off the exhaust gas system (4) downstream of the turbine (7) of the exhaust gas turbocharger (5) and including a low-pressure exhaust gas recirculation valve (12) and joining the fresh air system (2) upstream of the compressor (6) of the exhaust gas turbocharger (4), and
a condensate collection device (14) for collecting a condensate arranged in the fresh air system (13) at or downstream of the connecting point (13).

2. The internal combustion engine (1) according to claim 1, wherein the condensate collection device (14) is in the form of a collection tank.

3. The internal combustion engine (1) according to claim 1, wherein the condensate collection device (14) is incorporated into one of the branching-in point (13) and the fresh air system (2), in such a way that the condensate collected in the condensate collection device (14) is at least partly vaporizable by means of at least one of the exhaust gases re-circulated through the high-pressure exhaust gas recirculation pipe (8) and the exhaust gas recirculated through the low-pressure exhaust gas recirculation pipe (10).

4. The internal combustion engine (1) according to claim 1, wherein for an adjustment of an evaporation rate of the condensate collected in the condensate collection device (14), a quantity of exhaust gas, recycled by way of the high-pressure exhaust gas recirculation pipe (8) and the low-pressure exhaust gas recirculation pipe (10), can be controlled.

5. The internal combustion engine (1) according to claim 1, wherein
the internal combustion engine (1) has a control device (15) for an adjustment of a first quantity of exhaust gas, which is re-circulated by way of the high-pressure exhaust gas recirculation pipe (8) and for the adjustment of a second quantity of exhaust gas, which is recycled by way of the low-pressure exhaust gas recirculation pipe (10),
the first and second quantity being adjusted by means of the high-pressure exhaust gas recirculation valve (9) and by means of the low-pressure exhaust gas recirculation valve (12), respectively.

6. The internal combustion engine (1) according to claim 5, wherein the control device (15) is connected to the various control devices for controlling them so as to provide for the desired operation of the exhaust gas and fresh air systems (2, 4).

7. The internal combustion engine (1) according to claim 1, wherein the internal combustion engine (1) includes a condensate measuring device (18) for the determination the amount of condensate in the condensate collection device (14).

8. The internal combustion engine (1) according to claim 1, wherein
the first and/or second quantity of exhaust gas is adjustable by means of the control device (15) as a function of an operating condition of the internal combustion engine (1) and
the first and second quantity of exhaust gas is adjustable by means of the control device (15) in accordance with the quantity of condensate determined by the condensate measuring device (18) in the condensate collection device (14).

9. The method for the operation of an internal combustion engine (1) comprising
a fresh air system (2), with a charge air cooler (3) for feeding fresh air to the internal combustion engine (1),
an exhaust gas system (4) for the discharge of exhaust gas from the internal combustion engine (1),
at least one exhaust gas turbocharger (5), including a compressor (6) arranged in the fresh air system (2) upstream of the charge air cooler (3) and a turbine (7) arranged in the exhaust gas system (4),
a high-pressure exhaust gas recirculation pipe (8) extending between the exhaust gas system (4) and the fresh air system (2) for re-circulating exhaust gas from the exhaust gas system (4) to the fresh air system (2),
the high-pressure exhaust gas re-circulation pipe (8) branching off the exhaust gas system (4) upstream of the turbine (7) and including a high-pressure exhaust gas recirculation valve (9) and joining the fresh air system (2) downstream of the charge air cooler (3) at a connecting point (13),
a low-pressure exhaust gas recirculation pipe (10) including an exhaust gas recirculation cooler (11) for re-circulating exhaust gas from the exhaust gas system (4) to the fresh air system (2),
the low-pressure exhaust gas recirculation pipe (11) branching off the exhaust gas system (4) downstream of the turbine (7) of the exhaust gas turbocharger (5) and including a low-pressure exhaust gas recirculation valve (12) and joining the fresh air system (2) upstream of the compressor (6) of the exhaust gas turbocharger (4), and
a condensate collection device (14) for collecting a condensate arranged in the fresh air system (13) at or downstream of the connecting point (13),
the method comprising the steps of:
in a first operating condition of the internal combustion engine (1) re-circulating the exhaust gas essentially via the low-pressure exhaust gas recirculation pipe (10), and
in a second operating mode of the internal combustion engine (1) recirculating the exhaust gas essentially via the high-pressure exhaust gas recirculation pipe (8).

10. The method according to claim 9, wherein the internal combustion engine (1) is temporarily switched to the second operating mode, when, by means of the condensate measurement device (15), it is determined, that a quantity of condensate in the condensate collection device (14) exceeds a predetermined threshold value.
